(19) United States
(12) Patent Application Publication
(10) Pub. No.: US 2010/0318834 A1
(43) Pub. Date: Dec. 16, 2010

(54) Method and device for avionic reconfiguration

(75) Inventor: Thierry Planche, Vieille-Toulouse (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Airbus Operations (S.A.S.), Toulouse Cedex (FR)

(21) Appl. No.: 12/816,769

(22) Filed: Jun. 16, 2010

(30) Foreign Application Priority Data
Jun. 16, 2009 (FR) 09 54028

(51) Int. Cl. G06F 11/20

(52) U.S. Cl. 714/3; 714/E11.072

(57) ABSTRACT

The invention in particular has as an object a method and a device for reconfiguration of an avionic system comprising at least two computers and a software application, in an aircraft, each of the said computers being adapted for running the software application, the aircraft further comprising a module for detection of failure of at least one of the said computers as well as a loading module making it possible to load the software application into each of the computers. After an information item relating to the state of one of the computers has been received from the detection module, a failure of one of the computers is detected according to the information item received. A configuration according to which at least one application run by the faulty computer is run by another of the computers then is determined. The system then is reconfigured according to the determined configuration, the reconfiguration comprising the transmission of a request to the loading module to load the application run by the faulty computer into the other computer.

This invention relates to the architecture and the management of the avionics of an aircraft and more particularly to a method and a device for automatic or semi-automatic reconfiguration and maintenance of avionics.

Modern aircraft comprise more and more electronic and computer systems to improve their performances and to assist the pilot as well as the crew members during their missions. Thus, for example, the fly-by-wire controls make it possible to reduce the mechanical complexity of transmission of controls to the actuators and therefore the weight associated with these controls. Likewise, the presentation of pertinent information items enables the pilot to optimize the flight paths and to respond rapidly to any detected incident. Such information items are, in particular, speed, position, heading, meteorological and navigational data. These electronic and computer systems as a whole generally are called the avionics.

For reasons of reliability, the avionics often was shared functionally by specific modules, also called LRU (abbreviation for Line Replaceable Unit in English terminology). According to this architecture, a point-to-point transmission mode is used between each module. Thus, for example, the flight controls are handled in a special device while the electrical supply is handled in another one. In this way, a specific function is associated with each module.

Furthermore, each module supporting a critical function preferably is redundant so that the failure of one module does not bring about the loss of the associated function. The use of an aircraft utilizing a redundant module when the main module is faulty may necessitate a maintenance operation.

In order to improve the functionalities of the aircraft, to reduce the weight of the electronic equipment items by virtue of a greater integration, to reduce the costs by virtue of the use of generic modules, and to facilitate maintenance operations, the avionics now is more and more integrated according to an architecture called IMA (abbreviation for Integrated Modular Avionics in English terminology). According to this architecture, the functionalities of the avionic systems use as much as possible the generic computation and input/output resources in which they are implemented. Nonetheless, a system of segregation or partitioning makes it possible to isolate each of the functionalities so that the failure of one function does not affect another one.

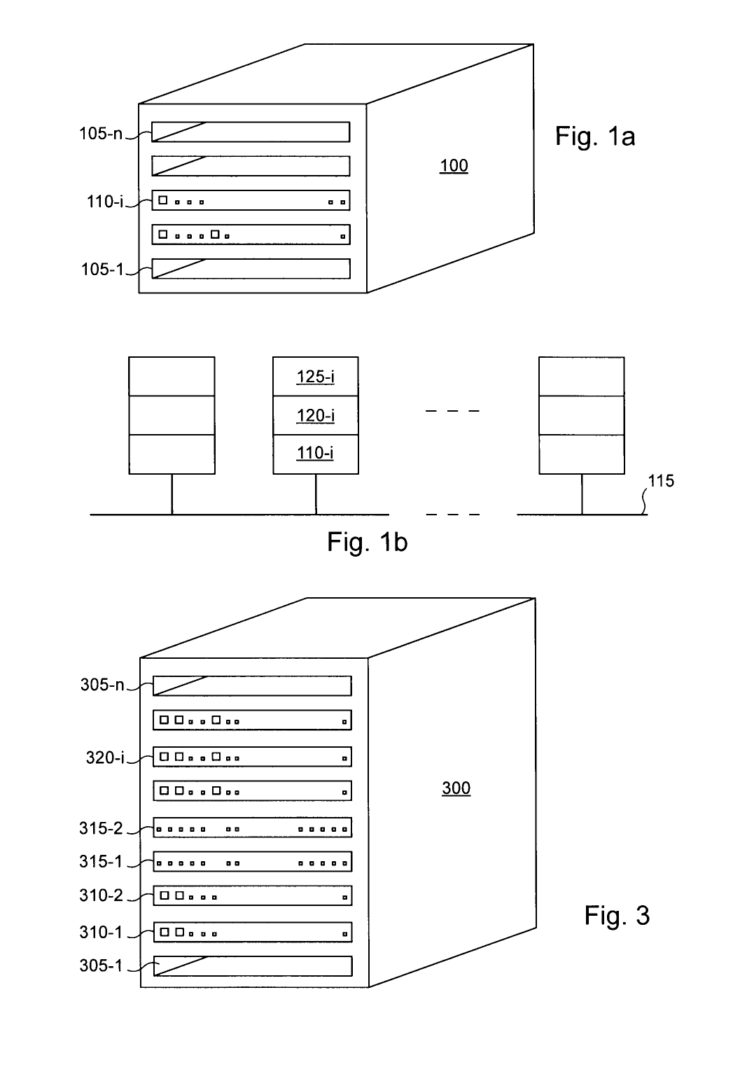

FIG. 1 a schematically illustrates an exemplary IMA architecture. Electrical box 100, also called electrical rack or cabinet in English terminology, here comprises bays 105-1 to 105-n adapted for accommodating boards, for example boards of PCB (abbreviation for Printed Circuit Board in English terminology) type. Electrical box 100 comprises in its rear portion connectors for connecting the boards inserted in bays 105-1 to 105-n to each other and for connecting these boards to the components of the aircraft. By way of illustration, electrical box 100 here comprises two generic computation boards, also called computers, referenced 110, adapted for running software applications for implementing avionic functions.

Each computer here comprises the resources that are necessary thereto, linked in particular, to the power supply and to the communication functions. By way of illustration, patent application FR 2 903 511 describes such an architecture.

FIG. 1b schematically illustrates the logic architecture associated with the IMA architecture illustrated on FIG. 1a. Computers 110 here may receive and/or transmit data via a network 115. Each computation unit 110-i comprises an operating system 120-i allowing the running of one or more applications 125-i.

Since the applications are not linked to a specific computation unit, the applications run by a computation unit may be transferred to another unused computation unit when a hardware failure is detected. Likewise, applications having a low priority level may be stopped in order to allow the running of applications having a higher priority level.

In other words, the IMA architecture offers a network layer, a hardware layer formed by the set of computation units, a low-level software layer and an applicative software layer providing avionic functions.

Although there are reconfiguration systems making it possible to shift the running of an application from one computer to another when a failure is detected, there nonetheless is a need to improve these systems for reconfiguration and maintenance of avionics.

The invention makes it possible to resolve at least one of the problems set forth above.

The invention thus has as an object a method for reconfiguration of an avionics system comprising at least two computers and at least one software application, in an aircraft comprising the said system, each of the said at least two computers being adapted for running the said at least one software application, the said aircraft further comprising a module for detection of failure of at least one of the said at least two computers as well as a module for loading of applications making it possible to load the said at least one software application into each of the said at least two computers, this method comprising the following steps,
reception, from the said detection module, of at least one information item relating to the state of at least one of the said at least two computers;
detection of at least one failure of at least one of the said at least two computers according to the said at least one information item;
determination of a configuration according to which at least one application run by the said at least one faulty computer is run by another of the said at least two computers;
reconfiguration of the said system according to the said configuration, the said step of reconfiguration comprising a step of transmission of a request to the said loading module to load the said at least one application run by the said at least one faulty computer into the said another of the said computers.

The method according to the invention thus applies to a device for automatic or semi-automatic reconfiguration of the generic computation resources used by the avionic functions making it possible to improve the operational availability of the aircraft while limiting interventions by maintenance personnel.

The method advantageously further comprises a step of reception of at least one information item relating to the state of the said aircraft, the said steps of detection, determination and reconfiguration being run according to the said at least one information item relating to the state of the said aircraft. In this way, the method according to the invention in particular may adapt the possibilities for reconfiguration according to the state of the aircraft in order to observe security constraints.

According to a specific embodiment, the method further comprises a step of validation of the said configuration in order to ensure the security of the aircraft.

Still according to a specific embodiment, the method further comprises a step of deactivation of the said at least one faulty computer in order, in particular, to reduce current consumption and power dissipation.

The method preferably further comprises a step of activation of an unused computer among the said at least two computers, the said at least one application run by the said at least one faulty computer being loaded into the said unused computer. In this way, the method makes it possible to optimize the use of the computers, in particular in terms of current consumption and power dissipation.

The method advantageously further comprises a step of transfer of an application run in a first computer of the said at least two computers to a second computer of the said at least two computers, the said at least one application run by the said at least one faulty computer being loaded into the said second computer.

Still according to a specific embodiment, the method also comprises a step of updating the at least one routing table, the said at least one routing table allowing at least one computer of the said at least two computers to exchange data with a device of the said aircraft. In this way the method according to the invention makes it possible to ensure a total transparency of the reconfiguration of an equipment item, no modification of the equipment items interacting with a reconfigured equipment item being necessary.

The invention also has as an object a computer program comprising instructions adapted for the implementation of each of the steps of the method described above when the said program is run on a computer, a device comprising means adapted for the implementation of each of the steps of the method described above as well as an aircraft comprising the device according to the preceding claim. The advantages obtained by such a computer program and such a device are similar to those cited above.

Other advantages, purposes and characteristics of this invention become apparent from the detailed description that follows, presented by way of non-limitative example, with reference to the attached drawings in which:

FIG. 1, comprising FIGS. 1a and 1b, schematically shows an exemplary IMA architecture;

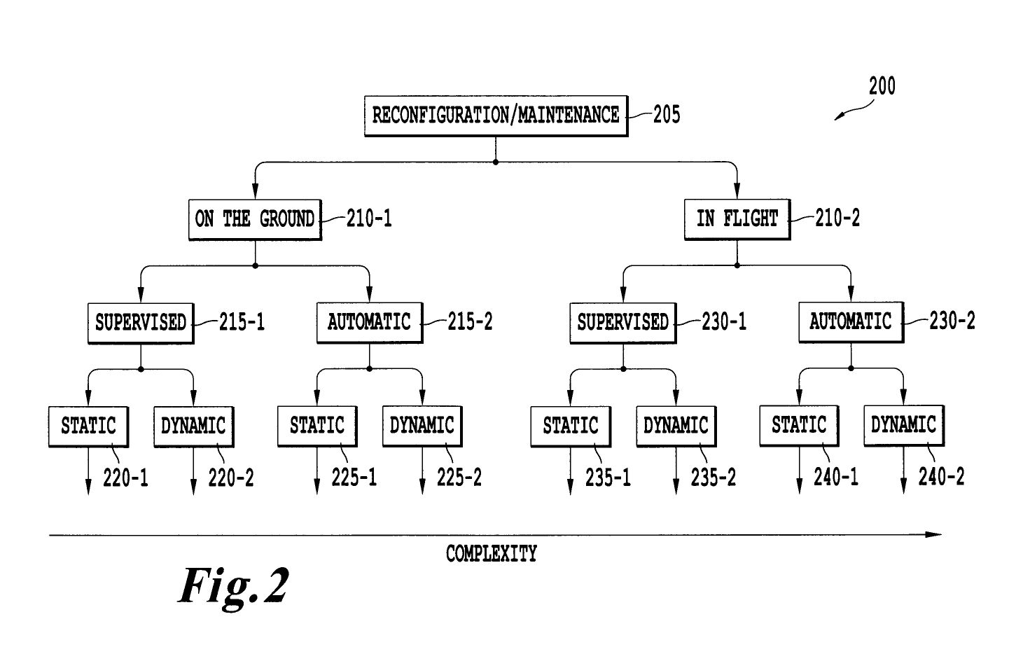

FIG. 2 schematically illustrates the various scenarios considered for the operations of reconfiguration and maintenance of avionics according to the state of the aircraft;

FIG. 3 schematically shows an exemplary cabinet architecture allowing reconfiguration thereof in accordance with the invention;

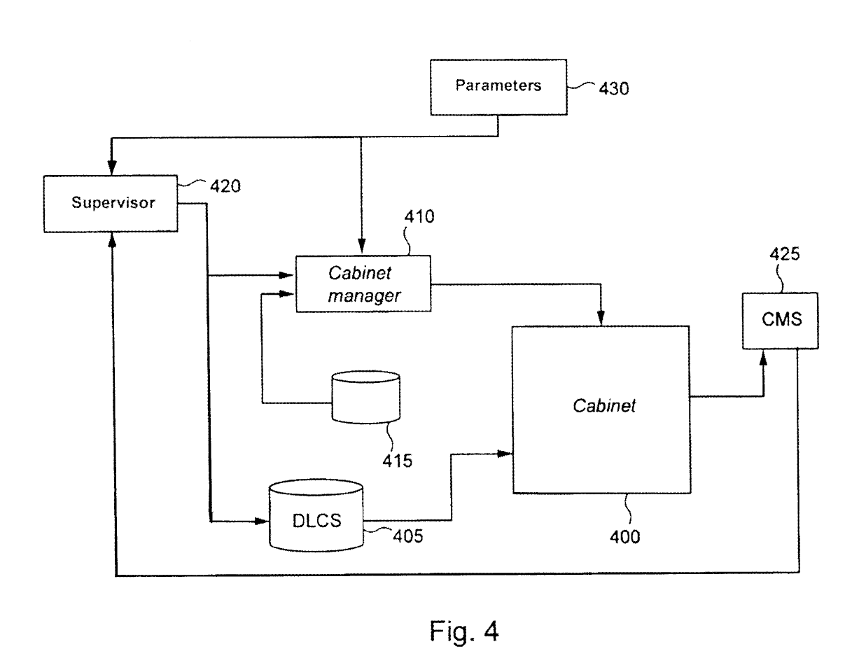

FIG. 4 schematically shows an exemplary architecture according to the invention allowing reconfiguration of the avionics;

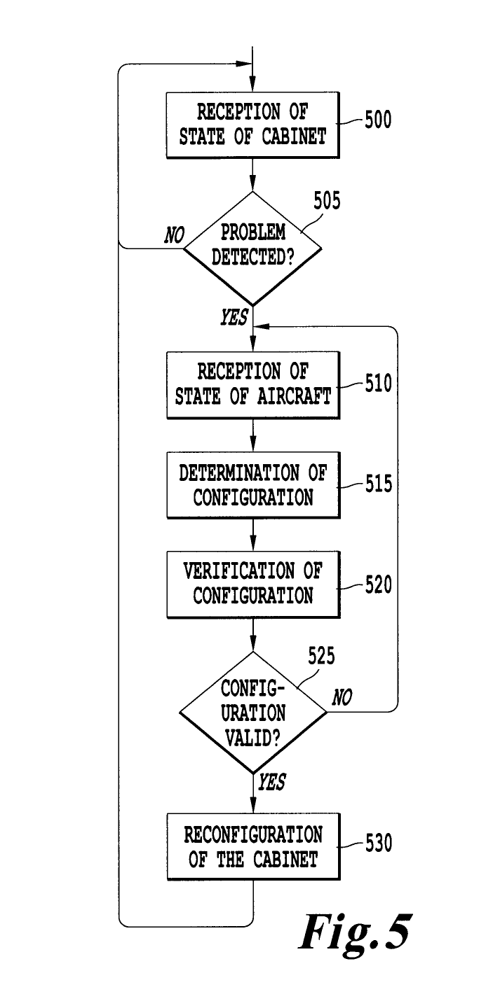

FIG. 5 schematically illustrates certain steps of an exemplary algorithm making it possible to determine a new configuration of the cabinet;

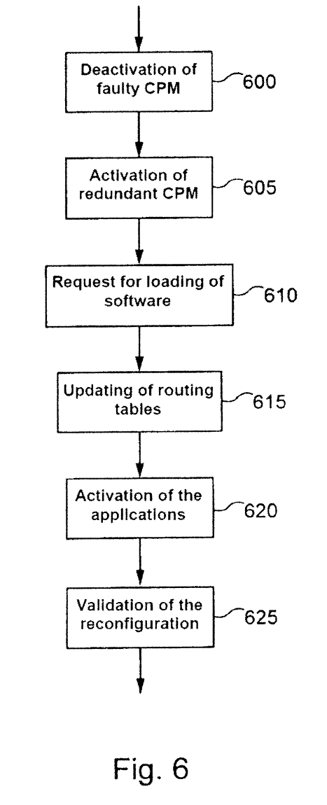

FIG. 6 schematically illustrates certain steps of an exemplary algorithm for reconfiguration of avionics in accordance with the invention;

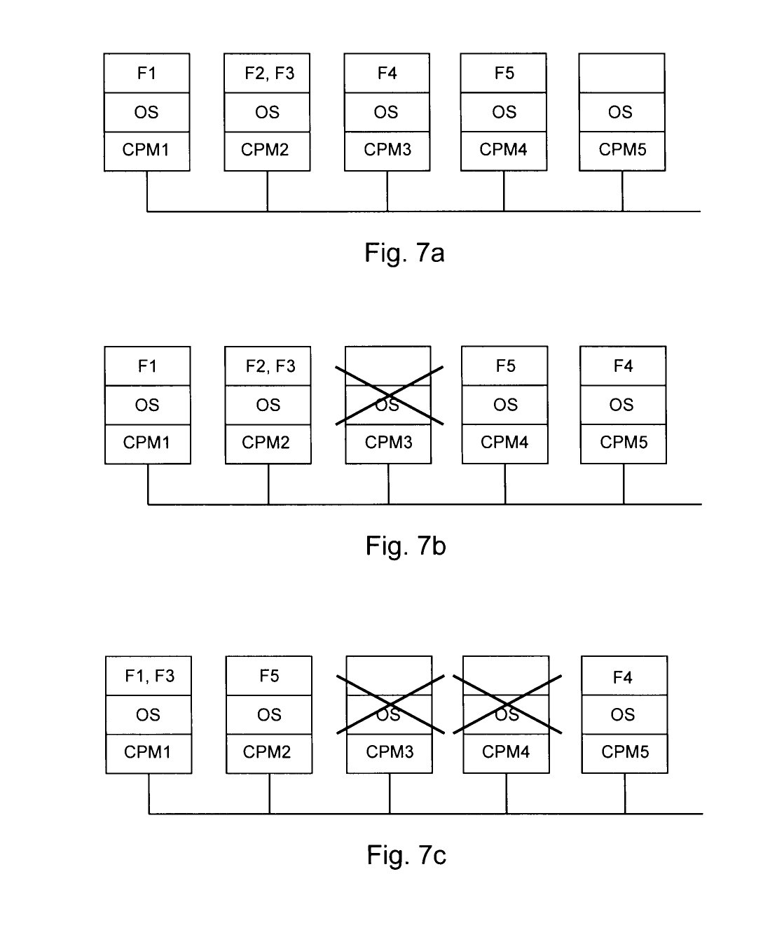

FIG. 7, comprising FIGS. 7a, 7b and 7c, illustrates an exemplary reconfiguration of an avionic system, in accordance with the invention, following the successive detection of two computer failures;

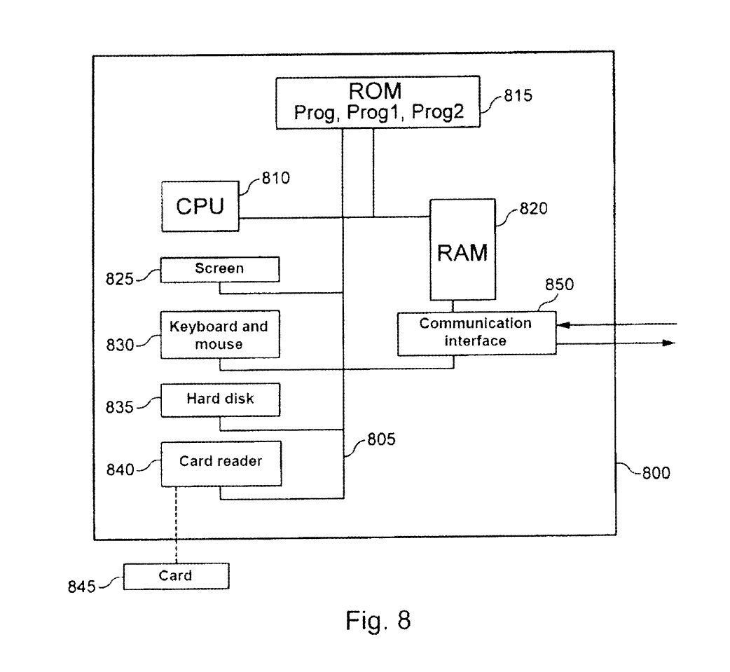

FIG. 8 illustrates an exemplary hardware architecture adapted for implementing the invention, in particular the algorithms shown on FIGS. 5 and 6.

The invention has as an object the reconfiguration and maintenance of avionics. These can be automatic or supervised, that is to say that the choices made by the reconfiguration and maintenance system are to be validated by an individual possessing the required level of competence. The validation may be carried out directly in the aircraft or remotely, for example from a maintenance center. Several implementations are considered depending, in particular, on whether the aircraft is in flight or on the ground.

FIG. 2 schematically illustrates the various scenarios 200 considered for the operations of reconfiguration and maintenance of avionics according to the state of the aircraft.

As illustrated, when a reconfiguration or maintenance phase 205 is to be implemented, in particular following the detection of a failure of a component of the avionics, it first of all is necessary to determine the state of the aircraft, for example on the ground (reference 210-1) or in flight (reference 210-2).

If the aircraft is on the ground, it then is necessary to determine whether the reconfiguration or maintenance phase is to be carried out according to a supervised (reference 215-1) or automatic (reference 215-2) mode. If the determined mode is the supervised mode, it still is necessary to determine whether the reconfiguration or maintenance phase is to be defined according to a predetermined static scheme (reference 220-1) or dynamically (reference 220-2).

According to the static scheme, all the acceptable configurations are predetermined, the reconfiguration and maintenance system being limited to choosing a specific configuration from among the set of configurations predetermined according to parameters identified beforehand. Such a scheme has the advantage of simplicity and security. In particular, a certification may be obtained more easily for such a deterministic scheme. Nonetheless, it may lead to situations for which no configuration has been determined and, consequently, not allowing an optimal operation of the aircraft.

Alternatively, according to the dynamic scheme, the optimal configuration is evaluated according to pertinent parameters in accordance with predetermined rules. Such a scheme makes it possible to optimize the use of the avionics and in particular to respond to problems of strings of failures. Nonetheless, the implementation of such a scheme may lead to certification difficulties.

If the determined mode is the automatic mode, it then is necessary to determine whether the reconfiguration or maintenance phase is to be defined according to a predetermined static scheme (reference 225-1) or dynamically (reference 225-2).

Likewise, if the aircraft is in flight, it is necessary to determine whether the reconfiguration or maintenance phase is to be carried out according to a supervised (reference 230-1) or automatic (reference 230-2) mode, according to a predetermined static scheme (references 235-1 and 240-1) or dynamically (references 235-2 and 240-2).

It should be noted here that, as indicated on the Figure, the complexity of the reconfiguration and maintenance system increases, in particular, with automation and dynamic management. In addition, for reasons of safety, the implementation of reconfiguration and maintenance operations is more complex and more critical in flight than on the ground.

The reconfiguration and maintenance scenario may be predetermined, that is to say that a single mode among modes 220-1, 220-2, 225-1 and 225-2 and/or 235-1, 235-2, 240-1 and 240-2 is implemented. Alternatively, several or all scenarios may be implemented, the choice of the scenario to be used being determined by a qualified individual according to certain conditions.

Naturally, other scenarios may be considered. In particular, when the aircraft is on the ground, it is possible to differentiate the taxiing phases, the loading/unloading phases and the maintenance phases.

By way of illustration, the following three scenarios may be used,
scenario 1 (on the ground): there is no special safety constraint with the exception of certain maintenance operations that cannot be carried out in specific configurations such as the filling of fuel tanks. The reconfiguration thus may be automatic and based, for example, on predetermined certified configurations. The reconfiguration also may be supervised and use a man-machine interface of the aircraft in order to validate the chosen configuration; and,
scenario 2 (in flight): in flight there are heavy safety constraints. The reconfiguration also is based, for example, on predetermined certified configurations. For applications having an impact on the safety of the aircraft, the reconfiguration advantageously is supervised. For comfort applications, however, the reconfiguration preferably is automatic so as not to disturb the crew during the mission.

FIG. 3 schematically shows an exemplary cabinet architecture, called DME (abbreviation for Distributed Modular Electronics in English terminology), based on an IMA architecture, allowing the reconfiguration of avionics in accordance with the invention.

Such an architecture in particular has as an object the mutualization of certain resources such as the communication links and the power supply.

Cabinet 300 here comprises bays 305-1 to 305-n adapted for accommodating boards, for example PCB-type boards, as well as, in its rear portion, connectors for connecting the boards inserted in bays 305-1 to 305-n to each other, via an internal communication bus, and for connecting these boards to the components of the aircraft via a communication network such as the AFDX (abbreviation for Avionics Full DupleX in English terminology) network. By way of illustration, cabinet 300 here comprises two redundant power supply boards, referenced 310-1 and 310-2, two redundant network-type boards, referenced 315-1 and 315-2, as well as computers, also called CPM (abbreviation for Core Processing Module in English terminology), referenced 320, adapted for running software applications.

CPMs 320 in particular share the resources made available to them by power supply boards 310-1 and 310-2 as well as by network-type boards 315-1 and 315-2. Other types of resources such as a mass storage may be shared in similar manner.

The modularity of cabinet 300 makes it possible to improve its characteristics, in particular in terms of weight and volume, but also to optimize the maintenance costs linked to replacement of faulty boards.

It also should be noted that such an architecture makes it possible to easily adapt the computation resources to the needs of the applications.

FIG. 4 schematically shows an exemplary architecture according to the invention, based on the DME architecture illustrated on FIG. 3, allowing reconfiguration of the avionics.

Electrical box 400, corresponding for example to cabinet 300 illustrated on FIG. 3, comprises generic computers on which the software applications providing the avionic functions are run. As indicated above, the computers are connected with each other, to the shared resources as well as to various devices of the aircraft.

Although the software applications are loaded into the computers, a copy thereof preferably is stored in a database 405, called DLCS (abbreviation for Data Loading Configuration System in English terminology). These copies make it possible in particular to configure each of the computers when they are changed in order to ensure the valid version of the software application.

Running of the applications by the generic computers here is controlled by a specific application 410, called cabinet manager in English terminology. The cabinet manager may be run in a specific system or in a generic computer. According to a particular embodiment, it is run in a specific module of the cabinet, for example the electrical supply system. The cabinet manager uses a database 415 making it possible in particular to store the configuration of the cabinet as well as the operational state of each board.

In general, the cabinet manager has as an object the management of each element of the cabinet, considered independently of the others, for example, the start-up and stopping, as well as that of the shared resources. The cabinet manager has the capacity to interact with each of the boards so as to verify in particular their functional state, their hardware and software configuration, especially the references called Part Number and Serial Number in English terminology, and, for certain boards lacking a computer, to program a non-volatile memory (called Non Volatile Memory in English terminology) that allows the maintenance shop to know the circumstances of the failure.

Furthermore, a supervision system 420, called RS (abbreviation for Reconfiguration Supervisor in English terminology), is used in particular in order to establish a diagnosis of the avionics via a diagnosis system 425, called CMS (abbreviation for Centralized Maintenance System in English terminology), and to determine and apply a new configuration thereof when a failure is detected. The RS therefore is alerted by the CMS to all the faults relating to the avionic equipment items, detected during self-testing of these modules or during operation of the equipment items, in flight or on the ground.

The CMS preferably is connected to each equipment item of the aircraft, especially to the BITE (abbreviation for Built In Test Equipment in English terminology) function or more generally to the function called Health Monitoring (HMon) in English terminology for each of these equipment items. The BITE or HMon functions comprise a logic making it possible to detect a failure of the monitored equipment item according to predetermined criteria and to transmit an alert message, in the form of a BITE or HMon message, to the CMS. The latter alerts the crew if necessary and stores the received information items in order to facilitate maintenance operations.

Each equipment item of electrical box 400, that is to say here each generic computer, supply system and network board, thus is equipped with a BITE or HMon function that is connected to CMS 425 as illustrated.

Supervision system 420 also is connected to a module 430 used to obtain parameters of the aircraft such as its state on the ground or in flight.

The architecture illustrated on FIG. 4 makes it possible to reconfigure the avionics, in particular to manage the computers used and the distribution of avionic applications on the latter. In this way, in general, when a failure is detected in the computer of cabinet 400, the latter transmits a BITE message to CMS 425 which alerts supervisor 420. The latter, after having verified the state of the aircraft with the aid of module 430 in order to verify that a reconfiguration may and should be performed, transmits its instructions to cabinet manager 410 to modify the active computers. Simultaneously, or sequentially, the supervisor transmits instructions to DLCS 405 to reload the applications to be run in the computers newly designated for this purpose as well as the routing tables for the AFDX network, so as to allow an automatic re-routing of the data exchanged by the reconfigured functions. This makes it possible to ensure a total transparency of the reconfiguration of an equipment item, no modification of the equipment items interacting with a reconfigured equipment item being necessary.

It should be noted here that two additional safety locks preferably are provided by the cabinet manager and by the computers themselves so as to prevent any erroneous or undesirable reconfiguration:
the cabinet manager has knowledge of the parameters of the aircraft as well as the criticality of the applications that are run by each of the computers so as to be able to reject an erroneous in-flight reconfiguration of an application critical for the flight, such as management of the fly-by-wire controls, the power system or management of the fuel; and,
each computer advantageously may reject the loading of a new software application, in particular when this loading is initiated during operational functioning of the computer if it is in conflict with the task of this computer.

FIG. 5 schematically illustrates certain steps of an exemplary algorithm making it possible to determine a new configuration of the cabinet.

After information items relating to the state of the cabinet have been received from the CMS (step 500), these information items are analyzed in order to determine whether a component of same is faulty (step 505). Tests of the faulty equipment item preferably are performed so as to confirm the diagnosis sent out by the CMS.

It should be noted here that the information items received make it possible to identify failures but also to determine the available resources.

If no indication of failure is detected in the cabinet, the algorithm returns to the preceding step.

Otherwise, if a failure is confirmed in the cabinet, and after reception of information items relating to the state of the aircraft (step 510), for example if it is on the ground or in flight, a new configuration is determined (step 515).

Each new configuration is determined according to the failure parameters received from the CMS and applying to the cabinet as well as according to the information items relating to the state of the aircraft. As indicated above, a new configuration may be determined dynamically according to predetermined rules or, alternatively, according to a predetermined decision tree. The actual choice between dynamic or static determination may be predetermined or result from the application of predetermined rules.

Predetermined, preferably certified, configurations may be stored in the form of tables comprising, for example, the list of computers and, for each of them, the list of the applications that they are responsible for running. Such tables also may comprise other information items such as the priority level of each application. These tables contain, for each valid configuration of the aircraft, all the possible reconfigurations and the identification of the equipment items to be activated as well as the applications to be shifted, including the configuration and routing tables for implementing these reconfigurations.

Furthermore, a decision graph may be stored for connecting the configurations to each other according to predetermined parameters. Thus, by way of illustration, the decision graph may be used to indicate that, if the avionics of an aircraft is in a configuration A and a failure is detected in computer X, the system is to be reconfigured according to configuration B.

When a configuration is determined, it is analyzed (step 520) in order to be validated (step 525). As indicated above, the validation may be automatic and accomplished according to predetermined rules or subject to the approval of a competent individual. In the latter case, the validation may be accomplished remotely by using standard validation and communication means.

If the configuration is not valid, the four preceding steps (steps 510 to 525) are repeated in order to identify another configuration. If, on the contrary, the configuration is valid, the cabinet is reconfigured according to same (step 530). The reconfiguration step is described in greater detail with reference to FIG. 6. The algorithm then returns to step 500 in order to be in a position to detect new failures.

The algorithm illustrated on FIG. 5 preferably is implemented in a supervision module such as supervisor 420 illustrated on FIG. 4. Nonetheless, this algorithm also may be implemented, at least partially, in the cabinet manager referenced 410 on FIG. 4.

FIG. 6 schematically illustrates certain steps of an exemplary algorithm for reconfiguration according to the invention. After the faulty computer has been deactivated (step 600) and, if need be, an available computer has been activated (step 605), in sequential or parallel manner, a request is transmitted to the DLCS to load the application or applications that were run by the faulty computer onto the designated computer (step 610).

It should be noted here that the step of activating an available computer is not systematically implemented, in particular when the cabinet does not comprise an available computer of if it is decided to run the application or applications previously run on the faulty computer on one or more partially used computers. Likewise, it may be decided to free up the resources of one or more computers according, for example, to the priority level associated with the applications being run in order to allow the running of new applications thereon.

The routing tables of the cabinet are updated in order to allow the new applications installed to communicate with the devices associated therewith (step 615). These routing tables are necessary for the functioning of the equipment items handling the AFDX communication network, called AFDX commutation switches or switches.

The applications then may be activated (step 620).

It should be noted here that partitions or virtual machines may be used in the computers. In this case, a standard step of activating the partitions or virtual machines is implemented.

The configuration then is validated (step 625) by comparing the real configuration of the cabinet with the configuration determined in order to compensate for the failure of a computer (step 515 of FIG. 5). If a difference is detected, an alert is generated.

The algorithm illustrated on FIG. 6 preferably is implemented in the cabinet manager (reference 410 of FIG. 4). Nevertheless, at least one part thereof also may be implemented in the supervisor (reference 420 of FIG. 4).

FIG. 7, comprising FIGS. 7a, 7b and 7c, illustrates an exemplary reconfiguration of an avionic system, in accordance with the invention, following the successive detection of two computer failures.

FIG. 7a shows the configuration of a cabinet at a given moment. As illustrated, the cabinet here comprises five computers CPM1 to CPM5 each having its operating system, also called OS (abbreviation for Operating System in English terminology). Computer CPM1 is running application F1, computer CPM2 is running applications F2 and F3, computer CPM3 is running application F4 and computer CPM4 is running application F5. Computer CPM5 here is inactive.

By way of illustration, it is assumed here that the priority level of application F2 is lower than that of application F3 which itself is lower than that of applications F1, F4 and F5.

When a failure is detected in computer CPM3, a new configuration is determined. The latter consists, for example, in shifting application F4 that was previously run by computer CPM3 to computer CPM5 that was unused.

As illustrated on FIG. 7b, computer CPM3 then is deactivated while computer CPM5 is activated. Application F4 then is loaded into computer CPM5 and the routing tables are updated in order to allow application F4 to exchange data with the devices of the aircraft (possibly including other software applications) with which it is associated.

If a failure subsequently occurs in computer CPM4, a new configuration is determined. Since no computer is available, this consists here in stopping certain applications so as to recover the necessary resources to allow running of the applications whose priority level is highest.

Thus, as illustrated on FIG. 7c, application F2 is stopped and application F3 is shifted to computer CPM1 so as to free up computer CPM2 which then is available to run application F5.

FIG. 8 illustrates an exemplary hardware architecture adapted for implementing the invention, in particular at least certain parts of the algorithms shown on FIGS. 5 and 6. Device 800 here comprises a communication bus 805 to which there are connected:
a central processing unit or microprocessor 810 (CPU, abbreviation for Central Processing Unit in English terminology);
a read-only memory 815 (ROM, acronym for Read Only Memory in English terminology) that may comprise the programs necessary for implementation of the invention;
a random-access memory or cache memory 820 (RAM, acronym for Random Access Memory in English terminology) comprising registers adapted for recording variables and parameters created and modified in the course of running of the aforesaid programs; and
a communication interface 850 adapted for transmitting and receiving data, in particular to and from the controlled devices of the aircraft in order to monitor them and know their state.

Device 800 preferably also has the following components:
a screen 825 making it possible to display data such as depictions of controls and able to serve as a graphical interface with the user who will be able to interact with the programs according to the invention, with the aid of a keyboard and a mouse 830 or another pointing device such as a touch screen or a remote control;
a hard disk 835 that may comprise the aforesaid programs and data processed or to be processed according to the invention; and
a memory card reader 840 adapted for receiving a memory card 845 and reading or writing therein data processed or to be processed according to the invention.

The communication bus allows communication and interoperability among the various components included in device 800 or connected thereto. The depiction of the bus is not limitative and, in particular, the central unit is able to communicate instructions to any component of device 800 directly or via another component of device 800.

The executable code of each program allowing the programmable device to implement the processes according to the invention may be stored, for example, on hard disk 835 or in read-only memory 815.

According to a variant, memory card 845 may contain data, in particular a table of correspondence between the events detected and the commands that may be requested, as well as the executable code of the aforesaid programs which, once read by device 800, is stored on hard disk 835.

According to another variant, the executable code of the programs will be able to be received, at least partially, via interface 850, to be stored in a manner identical to that described above.

More generally, the program or programs will be able to be loaded into one of the storage means of device 800 before being run.

Central unit 810 is going to control and direct the running of the instructions or portions of software code of the program or programs according to the invention, which instructions are stored on hard disk 835 or in read-only memory 815 or else in the other aforesaid storage components. During boot-up, the program or programs that are stored in a non-volatile memory, for example hard disk 835 or read-only memory 815, are transferred to random-access memory 820 which then contains the executable code of the program or programs according to the invention, as well as the registers for storing the variables and parameters necessary for implementation of the invention.

Naturally, in order to satisfy specific needs, an individual competent in the field of the invention will be able to apply modifications in the foregoing description.

1. Method for reconfiguration of an avionic system comprising at least two computers and at least one software application, in an aircraft comprising the said system, each of the said at least two computers being adapted for running the said at least one software application, the said aircraft further comprising a module for detection of failure of at least one of the said at least two computers as well as a module for loading of applications making it possible to load the said at least one software application into each of the said at least two computers, this method being characterized in that it comprises the following steps,
reception (500), from the said detection module, of at least one information item relating to the state of at least one of the said at least two computers;
detection (505) of at least one failure of at least one of the said at least two computers according to the said at least one information item;
determination (515) of a configuration according to which at least one application run by the said at least one faulty computer is run by another of the said at least two computers;
reconfiguration (530) of the said system according to the said configuration, the said step of reconfiguration comprising a step of transmission of a request to the said loading module to load the said at least one application run by the said at least one faulty computer into the said another of the said computers.

2. Method according to the preceding claim further comprising a step of reception (510) of at least one information item relating to the state of the said aircraft, the said steps of detection, determination and reconfiguration being run according to the said at least one information item relating to the state of the said aircraft.

3. Method according to claim 1 or claim 2 further comprising a step of validation (525) of the said configuration.

4. Method according to any one of the preceding claims further comprising a step of deactivation (600) of the said at least one faulty computer.

5. Method according to any one of the preceding claims further comprising a step of activation (605) of an unused computer among the said at least two computers, the said at least one application run by the said at least one faulty computer being loaded into the said unused computer.

6. Method according to any one of the preceding claims further comprising a step of transfer of an application run in a first computer of the said at least two computers to a second computer of the said at least two computers, the said at least one application run by the said at least one faulty computer being loaded into the said second computer.

7. Method according to any one of the preceding claims further comprising a step of updating (615) of at least one routing table, the said at least one routing table allowing at least one computer of the said at least two computers to exchange data with a device of the said aircraft.

8. Computer program comprising instructions adapted for the implementation of each of the steps of the method according to any one of the preceding claims when the said program is run on a computer.

9. Device comprising means adapted for the implementation of each of the steps of the method according to any one of claims 1 to 7.

10. Aircraft comprising the device according to the preceding claim.
